(19) United States
(12) Patent Application Publication
(10) Pub. No.: US 2008/0282052 A1
(43) Pub. Date: Nov. 13, 2008

(54) Operating Media Devices in Pre-Os Environment

(76) Inventors: Xiang Ma, Shanghai (CN); Yufu Li, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 10/577,579

(22) PCT Filed: Oct. 18, 2005
(86) PCT No.: PCT/CN05/01961

§ 371 Date: Apr. 27, 2006

(51) Int. Cl. G06F 9/26

(52) U.S. Cl. 711/202; 711/E12.001

(57) ABSTRACT

According to one embodiment, a method for initializing a plurality of media devices in communication with a computing device; mapping information corresponding to each initialized media device to a plurality of memory locations of the computing device; and operating the initialized media devices based on the mapped information corresponding to each operated media device while the computing device is in a pre-OS environment. According to another embodiment a system comprising a plurality of media devices in communication with a computing device and adapted for initialization by the computing device; and a memory mapping logic adapted to map information corresponding to the initialized media devices to a plurality of memory locations in a system memory of the computing device, wherein the computing device is adapted to operate the initialized media devices based on the mapped information corresponding to each operated media device while the computing device is in a pre-OS environment.

### FIELD

Embodiments of the invention relate to operating media devices by a computing device, and more particularly to operating media devices by a computing device in a pre-OS environment.

### BACKGROUND

The essential architecture of computer systems, such as personal computers, includes a central processing unit (CPU) in communication with a system memory that includes a memory medium and a memory controller interface. In addition, a computer system typically includes display interfaces, such as graphical interfaces, for operating video displays and input/output (I/O) control logic for various I/O devices, including a keyboard, mouse, floppy drive, hard drive, etc. An operating system (OS), such as Windows®, typically stored in the memory medium, monitors and conducts operations of the computer system, such as reading instructions and data from I/O devices and system memory. The operating system is typically loaded and executed from the system memory immediately following power-up (i.e. booting).

While the operating system provides the computer system with the ability to function, it is typically not the only means of booting a computer system. An alternative method commonly known as pre-OS booting, may also be employed to boot up a computer system. As the name suggests, pre-OS booting occurs prior to the loading and execution of the main operating system. In a typical pre-OS booting, a boot image file is accessed, such as from firmware, and executed, which results in the computer system to operate in a pre-OS environment Due to the limited instructions in the boot image file, however, the computer system's functionality during the pre-OS environment is also typically limited as compared to the functionality of the computer system during executions of a main operating system. One limitation is in the simultaneous operating of two or more media devices, such as video devices.

Currently, pre-OS firmware does not support the capability for allowing the computer system to interact with multiple devices at the same time. When multiple video devices are detected, the computer system typically selects one of the devices as the primary device and ignores all others. This is in part due to the limited decode range of the widely used video graphics array (VGA), which restricts the computer system to single VGA device usage, and in part due to computer system's inability to install and dispatch the multiple video option ROMs needed for interacting with multiple video devices at the same time.

### DETAILED DESCRIPTION OF THE INVENTION

The invention may best be understood by referring to the following description and accompanying drawings that are used to illustrate embodiments of the invention.

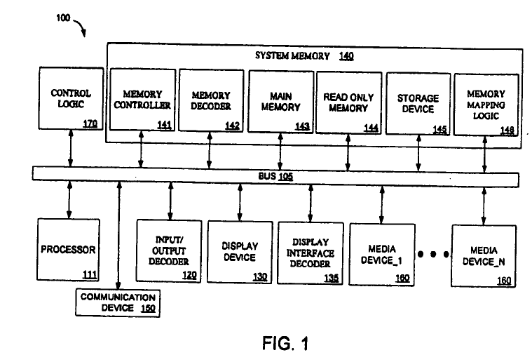

FIG. 1 is a block diagram of a computer system in which embodiments of the invention can be practiced.

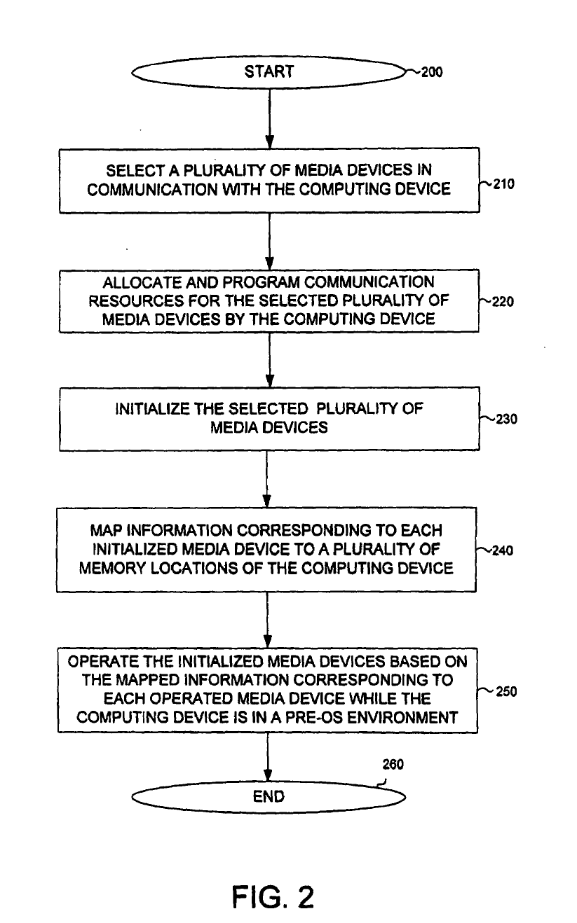

FIG. 2 is a flow chart illustrating a process according to an exemplary embodiment of the invention.

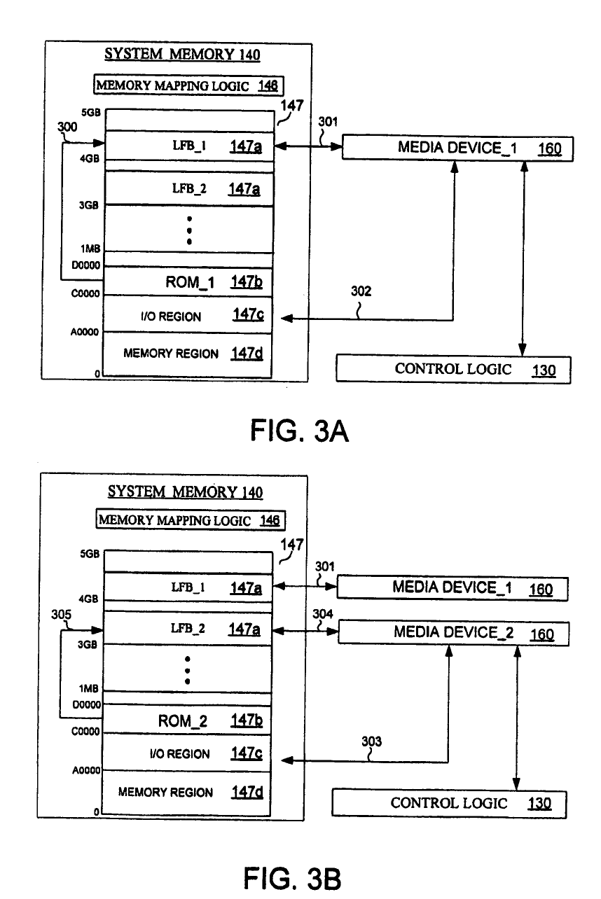

FIGS. 3A-B illustrate block diagrams of a system memory in which embodiments of the invention can be practiced.

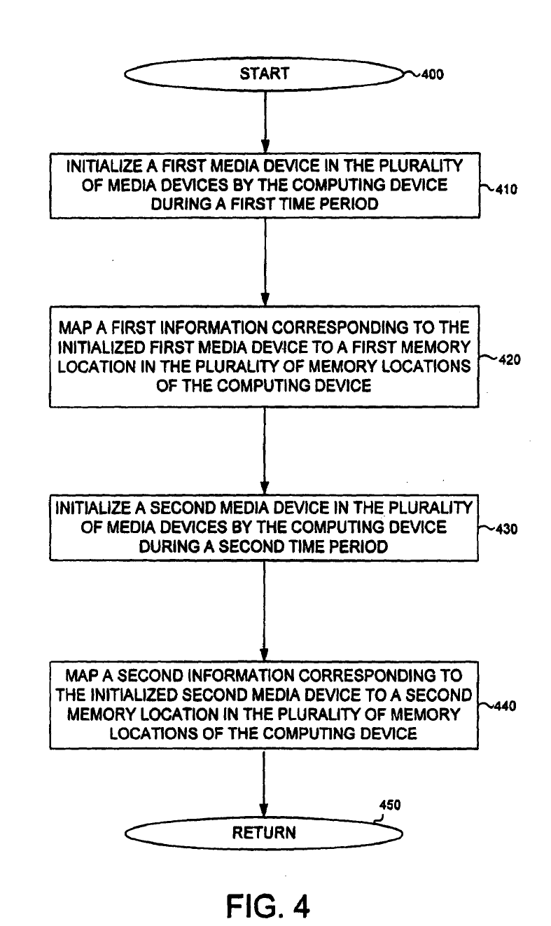

FIGS. 4-6 are flow charts further illustrating the processes according to exemplary embodiment of the invention shown in FIG. 2.

### DETAILED DESCRIPTION

Embodiments of the invention generally relate to a system and method for operating media devices by a computing device in a pre-OS environment. Herein, on embodiment of the invention may be applicable to media devices used in a variety of computing devices, which are generally considered stationary or portable electronic devices. Examples of a computing device may include, but are not limited or restricted to a computer, a set-top box, video game systems, music playback systems, and the like.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. Some embodiments of the invention are implemented in a machine-accessible medium. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.), etc.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the embodiments of the invention.

Also in the following description are certain terminologies used to describe features of the various embodiments of the invention. For example, the term “media device” refers any on-board or plug-in device, such as video cards, music players, or DVD players, for example, that is capable of storing video or audio data, such as movies, songs, etc. The term “linear buffer” refers to one or more buffers of a memory system in which obtained data and instructions can be stored. The term “software” generally denotes executable code such as an operating system, an application, an applet, a routine or even one or more instructions. The software may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVYD”), a hard drive disk, or tape. The term “pre-OS” (also known as pre-boot) environment refers to a setting in which tasks are performed before a main operating system (OS) is loaded, and may include limited use of a disk operating system (DOS).

With reference to FIG. 1, an embodiment of an exemplary computer environment is illustrated. In an exemplary embodiment of the invention, a computing device 100, such as a personal computer, comprises a bus 105, such as a Peripheral Component Interconnect (PCI) bus for example, or other communication medium for communicating information. A processor 111 is coupled to the bus 105 for processing information.

The computing device 100 further comprises a system memory 140 which comprises a main memory 143, such as random access memory (RAM) or other dynamic storage device as for storing information and instructions to be executed by the processor 111. Main memory 143 also may be used for storing temporary variables or other intermediate information during execution of instructions by the processor 111. The system memory 140 also may comprise a read only memory (ROM) 144 and/or other static storage devices 145 for storing static information and instructions for the processor 111, such as magnetic disk or optical disc and its corresponding drive, flash memory or other nonvolatile memory, or other memory device. Such elements may be combined together or may be separate components, and utilize parts of other elements of the computing device 100.

The system memory 140 also comprises a memory decoder 142 for translating between the addresses and storage format used by the processor 111 and the format used by memory chips and modules of memory system 140, such as main memory 115, ROM 144 and storage devices 145. The system memory 140 also comprises a memory controller 141 which controls the memory system 140 and a memory mapping logic 146 which may also be implemented in hardware or software stored in system memory 140. System memory 140 may also include other forms of storage (not shown) such as registers, caches etc.

The computing device 100 may also be implemented with a display device 130 coupled to a bus 105, such as a liquid crystal display (LCD) or other display technology, for displaying information to an end user. In some environments, the display device 130 may be a touch-screen that is also utilized as at least a part of an input device. In other environments, display device 130 may be or may include an auditory device, such as a speaker for providing auditory information.

Other devices included are media devices 160, shown as media device_1 through media device_N (N>1), which are devices capable of storing video or audio data, such as movies, songs, etc. The media device 160 communicates with the processor 111, and may further generate its results on the display device 130. A communication device 150 may also be coupled to the bus 105. Depending upon the particular implementation, the communication device 150 may include a transceiver, a wireless modem, a network interface card, or other interface device. The computing device 100 may be linked to a network or to other devices using the communication device 150, which may include links to the Internet, a local area network, or another environment. In an embodiment of the invention, the communication device 150 may provide a link to a service provider over a network. The computing device 100 also includes input/output (I/O) decoder 120, display interface decoder 135 and control logic 170 (stored in hardware or software) whose functions are described in greater detail in conjunction with FIGS. 3-6 below.

FIG. 2 is a flow chart illustrating a process according to an exemplary embodiment of the invention. The elements of the computing system 100 shown in FIG. 1 are referenced in conjunction with FIG. 2 for illustrative purposes. As shown in FIG. 2, following an action to start the process (block 200), a plurality of media devices 160 in communication with the computing device 100 are selected (block 210) following detection. Suitably at least one of the media devices 160 comprises an on-board device and a plug-in device, such as video devices (e.g., a video cards), audio devices (e,g, digital music players), and audio/video devices (e.g., DVD players). Next, communication resources, such as PCI bus resources, for the media devices 160 selected by the computing device are allocated and programmed (block 220).

The selected media devices 160 are then initialized (block 230), each at a different time period, as described in greater detail in conjunction with FIGS. 3-6 below. The information corresponding to each initialized media device 160 is then mapped (block 240) to different memory locations of the computing device 100 by the memory mapping logic 146, as described in greater detail in conjunction with FIGS. 3-6 below. Next, the computer system 100 operates, such as interacts with, the initialized media devices 160 based on the mapped information corresponding to each operated media device 160 (block 250). The operating of the initialized media devices 160 is performed while the computing device is in a pre-S environment. The process then ends (block 260).

The overall operations of the FIG. 2 will now be illustrated in further detail in conjunction with exemplary circuit block diagrams of FIGS. 3A-B and flow charts of FIG. 4-6. Referring to FIGS. 3A-B, for simplicity only two media devices 160, such as media device_1 and media device_2 are shown although embodiments of the invention are not limited to only two media devices 160. As shown in FIGS. 3A-B, a memory region 147 is selected by the system memory 140, such as in the main memory 143 or the storage device 145. The memory region 147 comprises addresses, such as from 0 to 5 GB. At the lower end of the addresses, such as 0 to C0000, are the I/O region 147c and memory region 147d in which is stored I/O and general information of a video graphics array (VGA) interface, such as a Legacy VGA interface. At the upper end of the addresses, such as 3 GB and higher, are a set of memory locations 147a, such as line fill buffers (LFB), such as LFB_1 and LFB_2. In an exemplary embodiment of the invention, the number of memory locations 147a used corresponds to number of the media devices 160 selected. In the example of FIGS. 3A-B, only two line fill buffers, LFB_1 and LFB_2 are shown since only two media devices 160, media device_1 and media device_2, are selected, for simplicity.

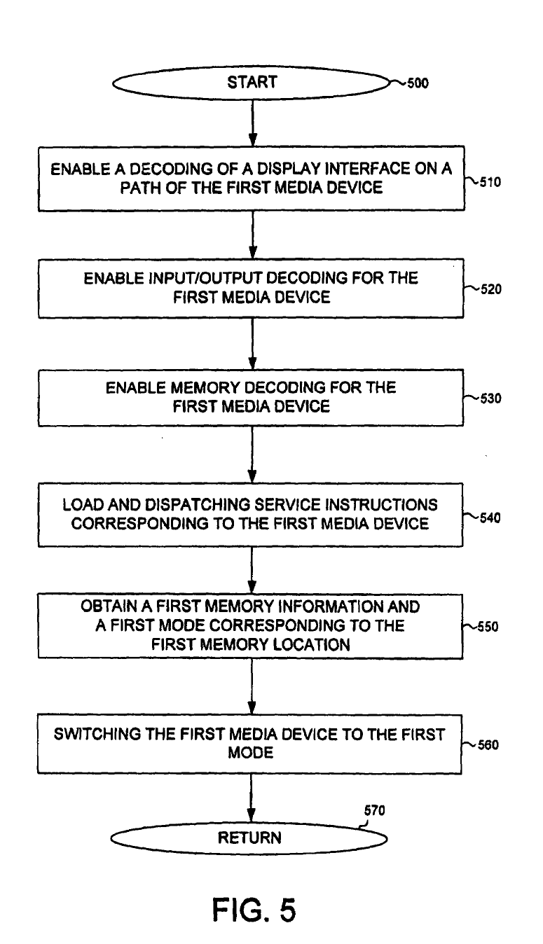

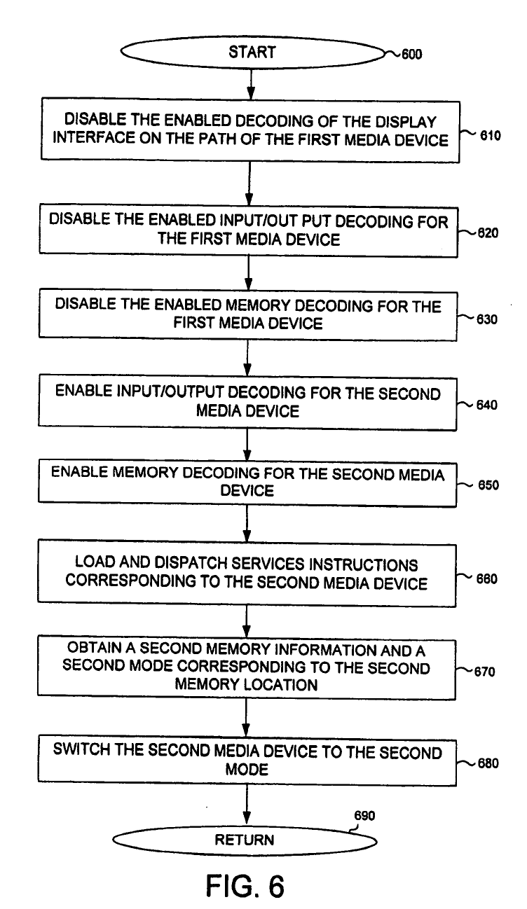

FIG. 4 is an exemplary flow chart further illustrating the initializing and mapping processes used in FIG. 2 (blocks 230, 240) in the context of the simplified example of FIGS. 3A-B when only two media device 160, media device_1 and media device_2 are selected. As shown in FIG. 4, the process starts (block 400) and proceeds to initialize a first media device 160, such as media device_1, during a first time period (block 410) as described in greater detail in conjunction with FIG. 5 below. Information corresponding to the initialized media device_1 is then mapped (shown symbolically by line 300 in FIG. 3A) by the memory mapping logic 146 to a memory location 147a corresponding to the media device_1, such as to LFB_1 (block 420). Next, a second media device 160, such as media device_2, is initialized (block 430) during a second time period that is subsequent to the first time period corresponding to the initialization of media device_1, as described in greater detail in conjunction with FIG. 6 below. Information corresponding to the initialized media device_2 is then mapped (shown symbolically by line 305 in FIG. 3B) by the memory mapping logic 146 to a memory location 147a corresponding to the media device_2, such as to LFB_2 (block 440). The flow is then returned (block 450) to FIG. 2 (block 240).

FIG. 5 is an exemplary flow chart further illustrating the initializing process for a first media device 160 illustrated in block 410 of FIG. 4. As shown in FIG. 5, the process starts (block 500) and proceeds to enabling a decoding of a display interface on a path of the media device_1, including all upstream buses 105, such as PCI buses (block 510). In an exemplary embodiment of the invention, the display interface comprises a video graphics array (VGA) interface, and the VGA decoding on the path of the media device_1 is performed by the display interface decoder 135 (shown in FIG. 1). Next, input/output decoding is enabled for the media device_1 (block 520), such as by media device_1, such as by using the Input/Output decoder 120 shown in FIG. 1. The input/output decoding is performed on the information stored in the I/O region 147c of FIG. 3A as described above.

A memory decoding is then enabled for the media device_1 (block 530), such as by using the memory decoder 142 shown in FIG. 1. The memory decoding is performed on the information stored in the memory region 147d of FIG. 3A as described above. Service instructions corresponding to the media device_1 are thereafter loaded and dispatched, such as by the memory controller 141 from the ROM 144 (block 540). The service instructions corresponding to the media device_1 may for instance include video service instructions, audio service instructions or both. For instance, the video service instructions may comprise option ROM instructions, such as option ROM_1 shown in FIG. 3A, stored in the ROM 144 and loaded into memory region 147b. A memory information and a mode corresponding to a memory location 147a, such as memory location LFB_1, is then obtained by the memory controller 141 (block 550). The media device_1 is thereafter switched by the control logic 170 to the mode obtained for the media device_1 (block 560). The flow is then returned (block 570).

As described above in conjunction with FIG. 4 (block 420), the information corresponding to the initialized media device_1 is mapped (shown symbolically by line 300 in FIG. 3A) to the memory location LFB_1 (obtained in block 550 of FIG. 5). The information corresponding to the initialized media device_1 may for instance include instructions and/or addresses corresponding to the media device_1 and those stored in regions 147b (such as ROM_1), 147c and 147d. Since the media device_1 was previously switched to an operation mode corresponding to the memory location LFB_1 (FIG. 5, block 560), the media device_1 will from thereon use the mapped information residing in memory location LFB_1 to interact with the computing device 100 (shown symbolically by line 301 in FIG. 3A), instead of interacting using the information stored in regions 147b, 147c and 147d (shown symbolically by line 302 in FIG. 3A).

FIG. 6 is an exemplary flow chart further illustrating the initializing process for a second media device 160 illustrated in blocks 430 of FIG. 4. As shown in FIG. 6, the process starts (block 600) and proceeds to disabling the enabled decoding of the display interface on the path of the media device_1, as previously illustrated in block 510 of FIG. 5 (block 610). The enabled input/output decoding for the media device_1 and the enabled memory decoding for the media device_1 are then disabled (blocks 620, 630). The input/output decoding and memory decoding for the media device_2 is enabled for the media device_2 (blocks 640, 650).

Following the foregoing enablement and disablement operation of block 610-650, the service instructions corresponding to the media device_2 are loaded and dispatched by memory controller 141 (block 660). According to an exemplary embodiment, the service instructions corresponding to the media device_2 comprises video service instructions, audio service instructions or both. The video service instructions may for instance comprise an option ROM instructions, such as option ROM_2 shown in FIG. 3B, stored in ROM 144 (FIG. 1) and loaded into memory region 147b. The storage of option ROM_2 instructions in the region 147b will partially or fully overwrite the previously stored option ROM_1 instructions in the region 147b. This however, will not affect the operation of the media device_1, since as described above the information needed for the operating of media device_1 by the computing device 100 is now residing in LFB_1. Next, a memory information and a mode corresponding to another memory location 147a, such a memory location LFB_2, is obtained by the memory controller 141 (block 670) and the media device_2 is switched by the control logic 170 to the mode obtained for the media device_2 (block 680). In an exemplary embodiment of the invention, the memory decoding for the media device_1 is re-enabled by the memory decoder 142 following the initialization of media device_2. The flow is then returned (block 690) to FIG. 4 (block 430).

As described above in conjunction with FIG. 4 (block 440), the information corresponding to the initialized media device_2 is mapped (shown symbolically by line 305 in FIG. 3B) to the memory location LFB_2 (obtained in block 670 of FIG. 6). The information corresponding to the initialized media device_2 may for instance include instructions and/or addresses corresponding to media device and those stored in regions 147b (such as ROM_2), 147c and 147d. The flow is then returned (block 450) to FIG. 2 (block 240). Since the media device_2 was previously switched to an operation mode corresponding to the memory location LFB_2 (FIG. 6, block 680), the media device_2 will from thereon use the mapped information residing in memory location LFB_2 to interact with the computing device 100 (shown symbolically by line 304 in FIG. 3B), instead of interacting using the information stored in regions 147b, 147c and 147d (shown symbolically by line 303 in FIG. 3A). The regions 147b, 147c and 147d can then be freed for initialization of additional selected media devices 160 in the manner described above.

In this way, as previously described in conjunction with FIG. 2 (block 250) the computing device 100 can separately operate and interact in a pre-OS environment with each of the media device_1 and media device_2. Thus, so long as each media device 160 is initialized at a different time period and set to a mode corresponding to the initialized media device 160, then line frame buffers 147a corresponding to each initialized media device 160 can be used to interact with each initialized media device 160 at the same time in a pre-OS environment, regardless of the information stored in regions 147b, 147c and 147d.

In an exemplary embodiment of the invention, the software that, if executed by a computing device 100, will cause the computing device 100 to perform the above operations described in conjunction with FIGS. 2-6 is stored in a storage medium, such as main memory 143, and storage devices 145. Suitably, the storage medium is implemented within the processor 111 of the computing device 100.

It should be noted that the various features of the foregoing embodiments were discussed separately for clarity of description only and they can be incorporated in whole or in part into a single embodiment of the invention having all or some of these features.

What is claimed is:

1. A method comprising:
initializing a plurality of media devices in communication with a computing device;
mapping information corresponding to each initialized media device to a plurality of memory locations of the computing device; and
operating the initialized media devices based on the mapped information corresponding to each operated media device while the computing device is in a pre-OS environment.

2. The method of claim 1, wherein each media device is initialized at a different time period corresponding to each initialized media device.

3. The method of claim 1, wherein each information corresponding to each initialized media device is mapped to a different memory location in the plurality of memory locations of the computing device.

4. The method of claim 1, further comprising:
initializing a first media device in the plurality of media devices by the computing device during a first time period;
mapping a first information corresponding to the initialized first media device to a first memory location in the plurality of memory locations of the computing device;
initializing a second media device in the plurality of media devices by the computing device during a second time period;
mapping a second information corresponding to the initialized second media device to a second memory location in the plurality of memory locations of the computing device; and
operating the initialized first and second media devices based on the mapped first and second information while the computing device is in the pre-OS environment.

5. The method of claim 4, wherein the initializing a first media device by the computing device comprises:
enabling a decoding of a display interface on a path of the first media device;
enabling input/output decoding for the first media device;
enabling memory decoding for the first media device;
loading and dispatching a service instructions corresponding to the first media device;
obtaining a first memory information and a first mode corresponding to the first memory location; and
switching the first media device to the first mode.

6. The method of claim 5, wherein the initializing a second media device by the computing device comprises:
disabling the enabled decoding of the display interface on the path of the first media device;
disabling the enabled input/output decoding for the first media device;
disabling the enabled memory decoding for the first media device;
enabling input/output decoding for the second media device;
enabling memory decoding for the second media device;
loading and dispatching a services instructions corresponding to the second media device;
obtaining a second memory information and a second mode corresponding to the second memory location; and
switching the second media device to the second mode.

7. The method of claim 4, wherein operating the first and second media devices based on the mapped first and second information comprises:
re-enabling memory decoding for the first media device; and
interacting with the first and second media devices in the first and second modes.

8. The method of claim 1, further comprising:
selecting a plurality of media devices in communication with the computing device for initializing; and
allocating and programming communication resources for the selected plurality of media devices by the computing device prior to the initializing the plurality of media devices.

9. A system comprising:
a plurality of media devices in communication with a computing device and adapted for initialization by the computing device; and
a memory mapping logic adapted to map information corresponding to the initialized media devices to a plurality of memory locations in a system memory of the computing device,
wherein the computing device is adapted to operate the initialized media devices based on the mapped information corresponding to each operated media device while the computing device is in a pre-OS environment.

10. The system of claim 9, further comprising:
a display interface decoder subsystem adapted to decode a display interface on a path of each media device and to be enabled and disabled;
an input/output decoder subsystem adapted to decode input/output for each media device, and to be enabled and disabled;
a memory decoder subsystem adapted to decode memory instructions for each media device, and to be enabled and disabled;
a memory controller adapted to load and dispatch service instructions stored in the system memory, and to obtain a memory information and a mode corresponding to each memory location corresponding to each media device; and
a control logic adapted to switch the each media device to a mode corresponding to the switched media device.

11. The system of claim 10, wherein each of the service instructions corresponding to each media device comprises at least one of a video service instructions and an audio service instructions.

12. The system of claim 11, wherein the video service instructions comprises an option ROM instructions, and wherein the display interface comprises a video graphics array (VGA) interface.

13. The method of claim 9, wherein the memory mapping logic is further adapted to map each information corresponding to each initialized media device to a different memory location in the plurality of memory locations of the computing device.

14. The system of claim 9, wherein at least one of memory location in the plurality of memory locations comprises a linear frame buffer.

15. The system of claim 9, wherein the information corresponding to each initialized media device comprises at least one of data, instructions, and addresses.

16. The system of claim 9, wherein the computing device is adapted to detect the media devices; and to allocate and program communication resources for the detected media devices prior to the initialization of at least one of the media devices.

17. The system of claim 9, wherein at least one of the media devices comprises an on-board device and a plug-in device, wherein at least one of the on-board device and a plug-in device comprises at least one of a video device, an audio device and a audio/video device.

18. A storage medium that provides software that, if executed by a computing device, will cause the computing device to perform the following operations:
initializing a plurality of media devices in communication with the computing device; and
operating the plurality of initialized media devices while the computing device is in a pre-OS environment.

19. The storage medium of claim 18, wherein each media device is initialized at a different time period corresponding to each initialized media device.

20. The storage medium of claim 18 further comprising software adapted to map information corresponding to each of the plurality of initialized media devices to a plurality of memory locations of the computing device, each of the plurality of memory locations being different memory locations.
